(19) United States
(12) Patent Application Publication
(10) Pub. No.: US 2008/0297467 A1
(43) Pub. Date: Dec. 4, 2008

(54) METHOD FOR BACKLIGHT MODULATION AND IMAGE PROCESSING

(75) Inventors: Ching-Fu Hsu, Taichung County (TW); Chih-Chang Lai, Taichung County (TW); Jyun-Sian Li, Tainan City (TW)

Correspondence Address: WPAT, PC, 7225 BEVERLY ST., ANNANDALE, VA, 22003, US

(73) Assignee: WINTEK CORPORATION, Taichung (TW)

(21) Appl. No.: 12/129,834

(22) Filed: May 30, 2008

Related U.S. Application Data
(60) Provisional application No. 60/940,826, filed on May 30, 2007.

(30) Foreign Application Priority Data
Jan. 3, 2008 (TW) 0971002025

(51) Int. Cl. G09G 3/36; G09G 5/00

(52) U.S. Cl. 345/102; 345/690; 382/168

(57) ABSTRACT

A method for backlight modulation and image processing is disclosed to control the backlight to modulate the brightness with different image data inputs and re-process the original image data. In the part of the backlight control, the method comprises acquiring a reference value, APL (average picture level), based on histogram analysis and the judgment process of backlight modulation by an algorithm. In the part of the image processing, the method comprises extracting a value correlating to the brightness from RGB data value with the transformation rule between different color spaces and re-mapping the value and outputting another image data value.

### BACKGROUND OF THE INVENTION

1. Field of the Invention

The present invention generally relates to a method for backlight modulation and image processing and, more particularly, to a method for controlling the brightness after backlight modulation and the image output value after image processing to enhance the contrast and maintain the hue.

2. Description of the Prior Art

In early years, in order to reduce power consumption for electronic devices having liquid crystal displays (LCDs), backlight intensity modulation is provided on the backlight module. Therefore, the user is able to decide whether the backlight module operates under a bright mode or a normal mode. The brightness is 400 cd/m² under the bright mode and 250 cd/m² under the normal mode. However, there are two major issues to be improved. First, it is an additional step for the user as he has to manually adjust the backlight module; and second, for different input image data, the image quality is affected when the backlight is too dark or too bright, which makes the user uncomfortable when viewing the image.

In U.S. Pat. No. 5,598,565, a power management system is installed to modulate power consumption to reduce the power consumption for electronic devices. The power management system modulates power consumption for the hard disk drive, the floppy disk drive and the flat panel display driver. For the control of power modulation over the hard disk drive and the floppy disk drive, the system sends a command to shut down the hard/floppy disk drive to reduce power consumption when a portable computer idles longer than it is pre-set by software.

For the control of power modulation over the flat panel display driver, the user switches the switch for the power saving mode to perform power saving control. When the power saving mode is switched on, the flat panel display driver is controlled for static or dynamic images. For static images, the cursor position is determined and the brightness in the other pixels is lowered while maintaining the brightness in the pixel where the cursor is positioned. For dynamic images, the power management system for the flat panel display driver analyzes frames. Since adjacent frames are almost alike, foreground information and background information are compared. Important foreground information is displayed full power because dynamic images usually appear in the foreground; and less important background information receives less power because those pixels are associated with a static background. The pixels receiving full power change on a frame-by-frame basis depending upon important information for that frame.

However, there are three problems in the method disclosed in U.S. Pat. No. 5,598,565. First, for the control of power modulation over the flat panel display driver, reduced power consumption is not achieved if the user uses the normal mode and does not switch to the power saving mode. Second, when the user uses the power saving mode, only a few pixels receive full power to remain the brightness while the brightness in the background is lowered, which makes the user uncomfortable because the frame seems darkened. Third, the image quality is worsened because of lowered refresh rate.

Moreover, in JP Laid-Open Patent Publication No. 8-201812, an LCD device capable of dynamically modulating the backlight module is disclosed. The LCD device comprises an average brightness detecting circuit and a backlight control portion. When the average brightness detecting circuit detects the average brightness level of a picture to be high, the backlight control portion lowers the backlight intensity. This patent effectively prevents the display from being too bright or too dark, which enables the user to use the LCD device easier and more comfortable. In other words, in this patent, the contrast for dark screen and bright screen is enhanced. However, when the average brightness level of a picture is low, loss of true black happens for black pixels as the brightness of the LCD device is increased to cause light leakage from the backlight. As a result, the image quality is worsened.

Moreover, in JP Laid-Open Patent Publication No. 2001-27890, a method for dynamically modulating the contrast of images and the brightness of the backlight is disclosed. In this method, the dynamic range of image signals is increased according to a compensation value based on the average brightness and the shifting of the image signals. Therefore, the contrast of the image on the display is enhanced. However, the dynamic range of image signals is increased to emphasize the defect in the image when there is an incomplete picture. If there is noise within the dynamic range of the image, noise can also be amplified and considered as a defect according to the user.

Moreover, in JP Laid-Open Patent Publication No. 6-102484, modulation is dynamically performed according to the correlation between the image signal and backlight control signal. In other words, the backlight brightness is reduced and the dynamic range of the image signal is expanded when a signal is at a dark level larger than a threshold value. Otherwise, no modulation is performed on the backlight brightness and the image signal if the dark level is not larger than the threshold value. Under the circumstances where the area at a bright level is not affected, brightness non-uniformity in the darker area is prevented. However, backlight brightness modulation according to this method is based on the dark level of the image without reference to other information such as average brightness of the image signal. Therefore, the image quality is not improved when there is no dark level image.

In U.S. Pat. No. 7,053,881, a method for dynamically modulating the image signal and backlight control signal is disclosed to overcome the problems in JP Laid-Open Patent Publication No. 8-201812. The method comprises steps of: inputting an image signal into a display control portion, an average brightness detecting portion and a peak detecting portion; displaying that the display control portion transforms the input image signal into a format for display; performing an average brightness operation on the image signal by the average brightness detecting portion to generate an average brightness signal and transmitting the average brightness signal to a backlight control portion to be used as a reference value for backlight modulation after performing the average brightness operation; and performing a peak value operation corresponding to the image signal by the peak detecting portion. The result of the peak value operation may be a high state 1 or a low state 0. A peak signal is then transmitted to the backlight control portion to be used as a reference value for backlight modulation. Therefore, in the backlight control portion the average brightness signal and the peak signal are both referenced for backlight modulation. Even though the contrast is less affected by the brightness variation because of the peak detecting portion, the image quality is worsened and cannot be maintained.

Therefore, to overcome the problems in the aforementioned prior art references, there is need in providing a method for backlight modulation and image processing to enhance the contrast and maintain the hue after backlight modulation and image processing.

### SUMMARY OF THE INVENTION

It is a primary object of the present invention to provide a method for backlight modulation and image processing is disclosed to control the backlight to modulate the brightness with different image data inputs and re-process the original image data. In the part of the backlight control, the method comprises acquiring a reference value, APL (average picture level), based on histogram analysis and the judgment process of backlight modulation by an algorithm. In the part of the image processing, the method comprises extracting a value correlating to the brightness from RGB data value with the transformation rule between different color spaces and re-mapping the value and outputting another image data value.

In order to achieve the foregoing object, the present invention provides a method for backlight modulation and image processing, comprising steps of: acquiring an average picture level (APL) by analyzing an image data and acquiring a backlight modulation ratio according to the average picture level; acquiring a first brightness factor by analyzing the image data and resetting the first brightness factor to a second brightness factor according to a brightness factor reset model; acquiring a factor ratio according to the first brightness factor and the second brightness factor; and acquiring an output image value according to the factor ratio and an input image value of the image data; whereby, backlight modulation is performed according to the backlight modulation ratio and image processing is performed according to the output image value.

According to the present invention, the method for backlight modulation and image processing is advantageous in:

1. Reduced power consumption by modulation of backlight brightness;

2. Eliminated image blinking during backlight modulation;

3. Enhanced contrast while the original image quality is maintained; and

4. Reduced backlight module thickness by using edge-emitting light-emitting diode (LED) according to the present invention.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a flow-chart of a method for backlight modulation and image processing according to the present invention;

FIG. 2A is a flow-chart of a method for acquiring an average picture level according to the present invention;

FIG. 2B is a flow-chart of another method for acquiring an average picture level according to the present invention;

FIG. 2C is a graph showing a curve for acquiring image data according to the present invention;

FIG. 3A is a flow-chart of a method for image processing according to the present invention;

FIG. 3B is a graph showing the relation of the average picture level and the backlight modulation ratio according to the present invention;

FIG. 4 is a histogram of image data corresponding to three different images according to the present invention;

FIG. 5A is a graph showing the brightness factor reset model I used in FIG. 4;

FIG. 5B is a graph showing the brightness factor reset model II used in FIG. 4;

FIG. 5C is a graph showing the brightness factor reset model III used in FIG. 4;

FIG. 6A is an input image according to another embodiment the present invention;

FIG. 6B is a graph showing the brightness factor reset model according to the present embodiment;

FIG. 6C is the image in FIG. 6A after image processing; and

FIG. 6D is the image in FIG. 6C after backlight modulation.

### DETAILED DESCRIPTION OF THE PREFERRED EMBODIMENT

The present invention providing a method for backlight modulation and image processing can be exemplified by the preferred embodiments as described hereinafter.

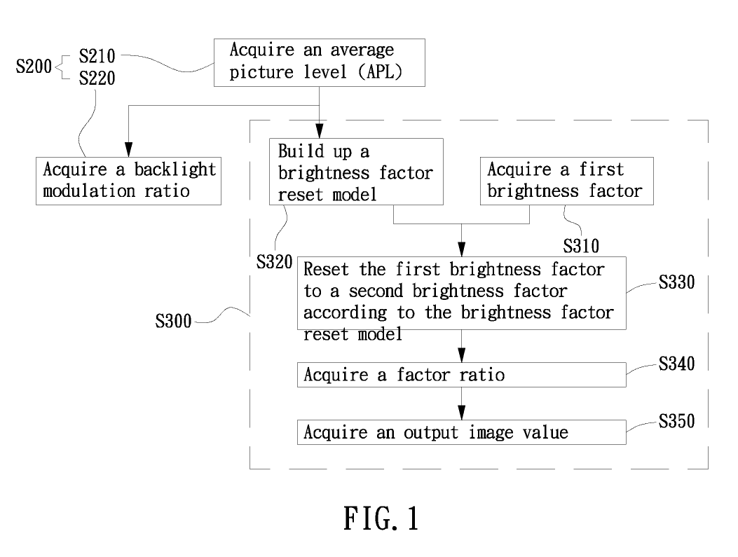

Please refer to FIG. 1, which is a flow-chart of a method for backlight modulation and image processing according to the present invention. The method comprises steps:

Step S200: a backlight modulation step; and

Step S300: an image processing step.

Step S200 comprises steps as described hereinafter.

In Step S210, an average picture level (APL) is acquired. In Step S220, a backlight modulation ratio is acquired.

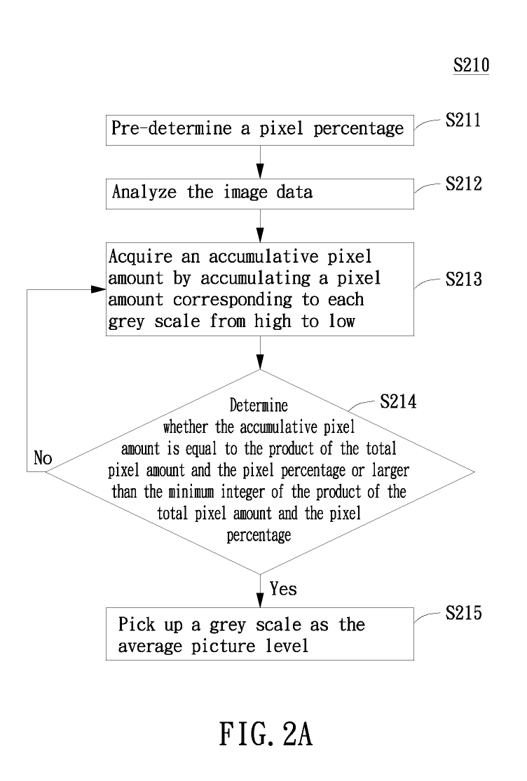

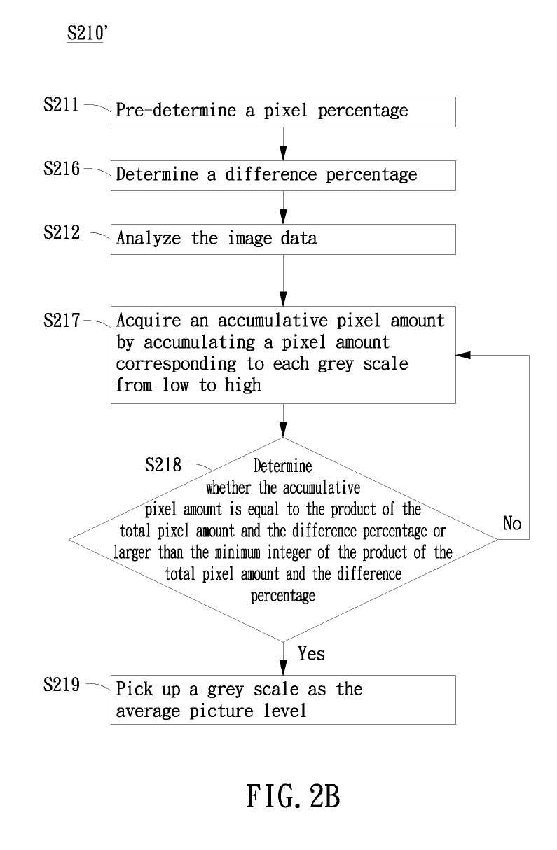

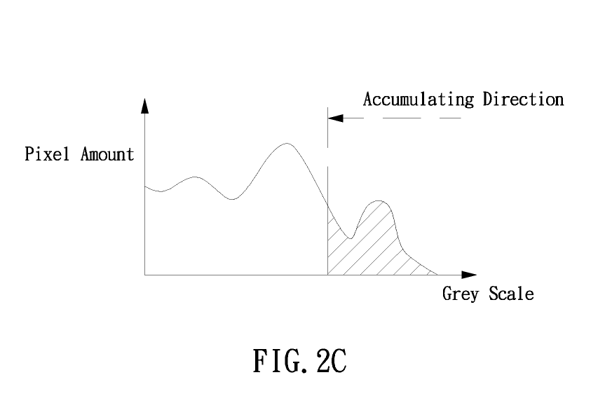

Please refer to FIG. 2A, which is a flow-chart of Step S210 for acquiring an average picture level according to the present invention. Step S210 comprises steps as described hereinafter.

In Step S211, a pixel percentage is pre-determined. In Step S212, the image data is analyzed. More particularly, the grey scale in each pixel of the image is analyzed and the pixel amount of the same grey scale is calculated to build up a histogram for calculating the total pixel amount of the image. In the histogram, the grey scale in each pixel is based on the sub-pixel data of each pixel, for example, max(R, G, B), ⅓*(R+G+B) or 0.299×R+0.587×G+0.114×B. R, G and B represent the image data in the RGB model. However, the present invention is not limited thereto.

In Step S213, an accumulative pixel amount by accumulating a pixel amount corresponding to each grey scale from high to low is acquired to analyze the bright/dark ratio.

In Step S214, it is determined whether the accumulative pixel amount is equal to the product of the total pixel amount and the pixel percentage or larger than the minimum integer of the product of the total pixel amount and the pixel percentage.

In Step S215, a grey scale is picked up as the average picture level if the accumulative pixel amount is equal to the product of the total pixel amount and the pixel percentage or larger than the minimum integer of the product of the total pixel amount and the pixel percentage after Step S214.

Please refer to FIG. 2B, which is a flow-chart of Step S210′ for acquiring an average picture level according to the present invention. Step S210′ comprises steps as described hereinafter.

In Step S211, a pixel percentage is pre-determined. In Step S216, a difference percentage is determined by subtracting the pixel percentage from 1. In Step S212, the image data is analyzed. More particularly, the grey scale in each pixel of the image is analyzed and the pixel amount of the same grey scale is calculated to build up a histogram for calculating the total pixel amount of the image.

In Step S217, an accumulative pixel amount by accumulating a pixel amount corresponding to each grey scale from low to high is acquired to analyze the bright/dark ratio.

In Step S218, it is determined whether the accumulative pixel amount is equal to the product of the total pixel amount and the difference percentage or larger than the minimum integer of the product of the total pixel amount and the difference percentage.

In Step S219, a grey scale is picked up as the average picture level if the accumulative pixel amount is equal to the product of the total pixel amount and the difference percentage or larger than the minimum integer of the product of the total pixel amount and the difference percentage after Step S218.

Please refer to FIG. 2C, which is a graph showing a curve for acquiring image data according to the present invention. The average picture level is acquired based on histogram analysis. The acquiring process analyzes the grey scale in each pixel of the image. The pixel amount corresponding to each grey scale is calculated to analyze the bright/dark ratio and the total pixel amount of the image. In order to determine the bright/dark ratio, the accumulative pixel amount by accumulating a pixel amount corresponding to each grey scale from high to low based on the histogram is acquired. Also, it is determined whether the accumulative pixel amount is equal to the product of the total pixel amount and the pixel percentage or larger than the minimum integer of the product of the total pixel amount and the pixel percentage. If the accumulative pixel amount is equal to the product of the total pixel amount and the pixel percentage or larger than the minimum integer of the product of the total pixel amount and the pixel percentage, the grey scale is picked up as the average picture level.

For example, if the pre-determined pixel percentage is 25%, the bright/dark ratio can be obtained after the image data is analyzed. The accumulative pixel amount is acquired by accumulating a pixel amount corresponding to each grey scale from high to low. When the accumulative pixel amount is equal to 25% of the total pixel amount, the grey scale is picked up as the average picture level. If the accumulative pixel amount is acquired by accumulating a pixel amount corresponding to each grey scale from low to high, the difference percentage is defined by subtracting the pixel percentage from 1. In this case, the difference percentage is 75%. When the accumulative pixel amount is equal to 75% of the total pixel amount, the grey scale is picked up as the average picture level.

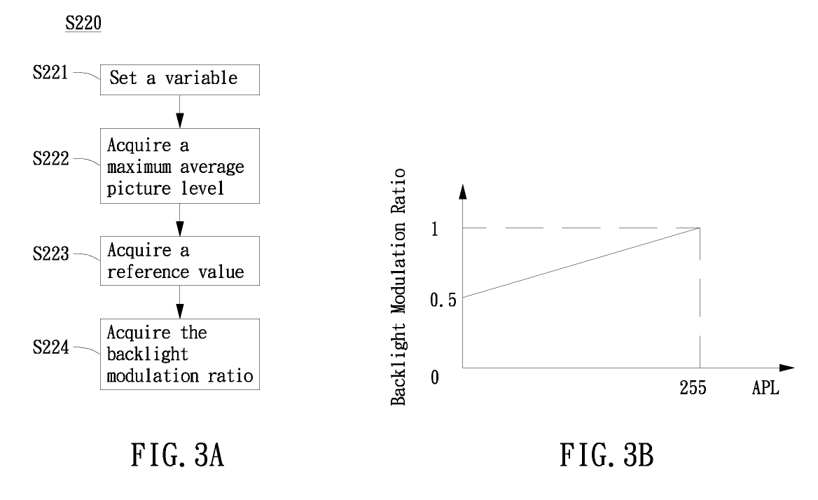

Please refer to FIG. 3A and FIG. 3B, wherein FIG. 3A is a flow-chart of a method for image processing according to the present invention and FIG. 3B is a graph showing the relation of the average picture level and the backlight modulation ratio according to the present invention.

Step S220 comprises steps as described hereinafter.

In Step S221, a variable is set. In Step S222, a maximum average picture level (APLₘₐₓ) is acquired. In Step S223, a reference value is acquired. In Step S224, the backlight modulation ratio is acquired.

The maximum average picture level (APLₘₐₓ) is acquired by reading a bit number n of the image data to be calculated. If the bit number n of the image data is 8, the maximum average picture level (APLₘₐₓ) is 2⁸−1. A reference value (m) is acquired to be an integer of the difference between 1 and the variable (1−var) or larger than the minimum integer of the maximum average picture level (APLₘₐₓ) divided by a difference between 1 and the variable (1−var). In other words,

m=APLₘₐₓ/(1−var)

where m is an integer

otherwise,

m>APLₘₐₓ/(1−var)

where m is a minimum integer

The backlight modulation ratio (BackDim) is acquired by adding the variable (var) to the average picture level divided by the reference value. In other words, the backlight modulation ratio can be expressed as:

BackDim=(APL/m)+var

For example, if the variable is 0.5 and the bit number is 8, the maximum average picture level (APLₘₐₓ) is 255. Therefore, the reference value (m) can be calculated to be 510. The backlight modulation ratio can be rewritten as:

BackDim=(APL/510)+0.5

Accordingly, after the average picture level is acquired, the average picture level can be used in the backlight modulation equation to acquire the backlight modulation ratio. Moreover, since the relation between the average picture level and the backlight modulation ratio is linear, the image brightness can be more adaptively modulated during backlight modulation so that the image is displayed (statically or dynamically) without blinking. The modulation results depend on different images.

Referring to FIG. 1 again, Step S300 further comprises steps as described hereinafter.

In Step S310, a first brightness factor is acquired. In Step S320, a brightness factor reset model is built up. In Step S330, the first brightness factor is reset to a second brightness factor according to the brightness factor reset model. In Step S340, a factor ratio is acquired. Also, in Step S350, an output image value is acquired.

More particularly, in Step S310, the image data is transformed from the RGB model into the YUV model so as to acquire the brightness factor in the YUV model.

the first brightness factor is a brightness factor in the YUV model obtained by transforming the image data from the RGB model into the YUV model. In the YUV model, Y is a brightness factor and U, V are color factors. In the present embodiment, only the brightness factor is acquired as a first brightness factor because only backlight is modulated. Transformation from the RGB model into the YUV model can be represented by a transform equations stated as follows:

Y=max(R,G,B);

Y=⅓*(R+G+B); or

Y=0.299×R+0.587×G+0.114×B

R, G, B represent the image data in the RGB model. However, the present invention is not limited to the above mentioned equations. The equation Y=0.299×R+0.587×G+0.114×B is used hereinafter as an example.

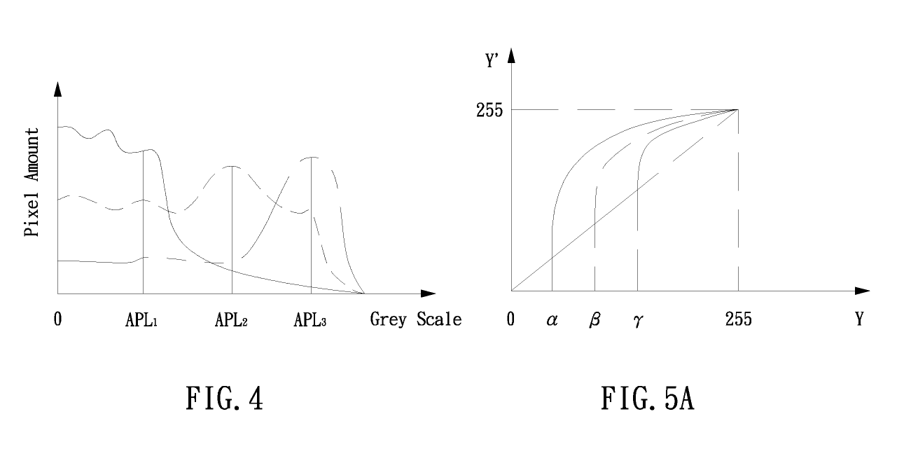

Please refer to FIG. 4, which a histogram of image data corresponding to three different images according to the present invention. If the pixel percentage is set to be 25%, the pixel amount corresponding to each grey scale is accumulated from high to low until the accumulative pixel amount is larger than 25% of the total pixel amount. Three grey scales can be acquired based on the histogram as average picture levels APL₁, APL₂, APL₃, which are between 0 and 255.

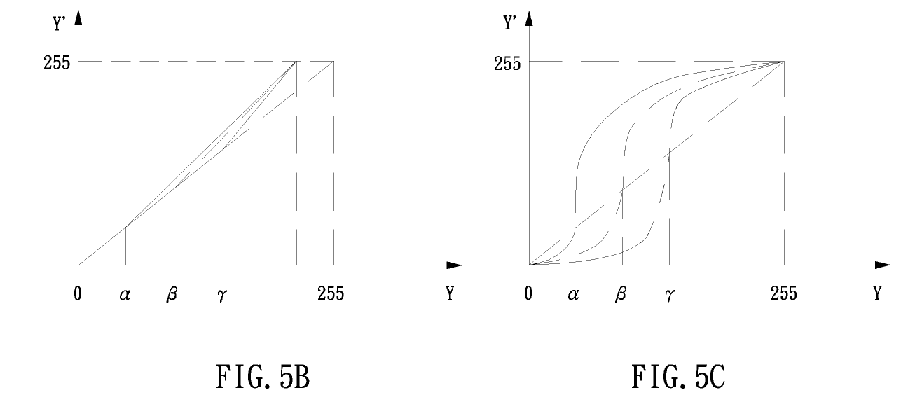

Please refer to FIG. 5A, FIG. 5B and FIG. 5C, which show the brightness factor reset models I, II, and III used in FIG. 4. When the average picture level is lower (for example, APL₁ in FIG. 4), indicating that the image is determined to be darker, the turning point on the corresponding reset curve is at Y=α and the transition region for the bright mode is larger so that the backlight brightness is modulated much lowered. Otherwise, when the average picture level is medium (for example, APL₂ in FIG. 4), indicating that the image is determined to be moderate, the turning point on the corresponding reset curve is at Y=β and the transition region for the bright mode in the brightness factor reset model is nearly half so that the backlight brightness is modulated moderately. Otherwise, when the average picture level is higher (for example, APL₃ in FIG. 4), indicating that the image is determined to be brighter, the turning point on the corresponding reset curve is at Y=γ and the transition region for the bright mode in the brightness factor reset model is narrower so that the backlight brightness is moderately a little bit lowered. More particularly, β is between α and γ.

In other words, in Step S320, it is preferable that the first brightness factor is reset by the reset curve to the second brightness factor, which is larger than the first brightness factor when the first brightness factor is larger than the turning point on the reset curve; the first brightness factor is reset by the reset curve to the second brightness factor, which is smaller than or equal to the first brightness factor when the first brightness factor is smaller than the turning point on the reset curve; and the second brightness factor is equal to the first brightness factor when the first brightness factor is equal to the turning point on the reset curve.

In Step S330, the first brightness factor is reset to the second brightness factor according to the brightness factor reset model.

In Step S340, the factor ratio (FR) is acquired by dividing the second brightness factor (Y′) by the first brightness factor (Y), expressed as:

FR=Y′/Y

In Step S350, the output image value (Ro,Go,Bo) is acquired by multiplying the factor ratio (FR) with an input image value (Ri,Gi,Bi) of the image data. That is,

Ro=FR×Ri; Go=FR×Gi; Bo=FR×Bi

Accordingly, the backlight modulation step S200 and the image processing step S300 are integrated to achieve reduced power consumption by modulating the backlight brightness and to enhance the contrast and maintain the hue.

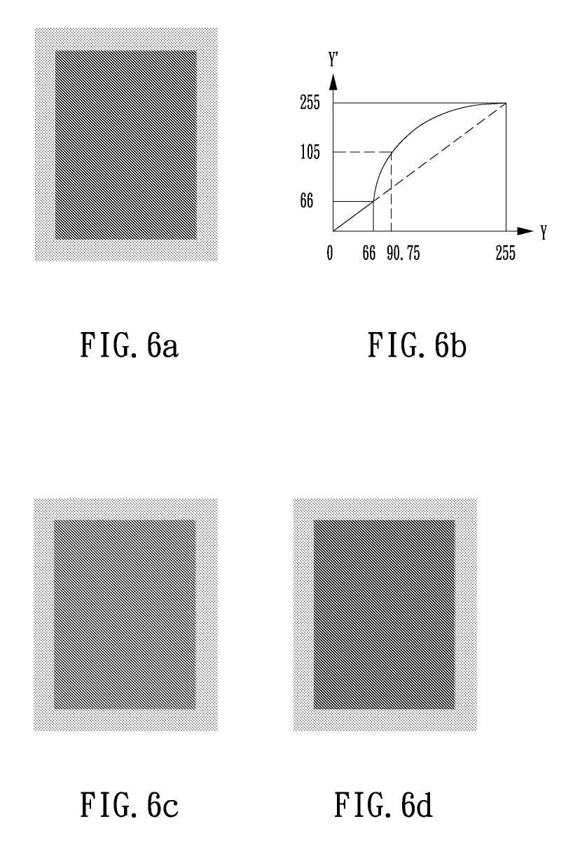

For example, please refer to FIG. 6A, which is an input image according to another embodiment the present invention. Backlight modulation is performed for the input image to be processed. The input image value (Ri, Gi, Bi) is (50, 100, 150). According to the present invention, the input image value is transformed from the RGB model to the YUV model according to the equation stated as:

$$\begin{matrix}Y = 0.299 \times R + 0.587 \times G + 0.114 \times B \\ = 0.299 \times 50 + 0.587 \times 100 + 0.114 \times 150 \\ = 90.75\end{matrix}$$

Therefore, the first brightness factor (Y) is 90.75.

Please refer to FIG. 6B, which is a graph showing the brightness factor reset model according to the present embodiment. According to the brightness factor reset model in FIG. 6B, the turning point on the reset curve is at Y=66 to reset the first brightness factor (Y) to the second brightness factor (Y′). Since the first brightness factor (Y) is 90.75, it is obtained that the second brightness factor (Y′) is 105. Therefore, the factor ratio (FR) is

FR=Y′/Y=105/90.75=1.167

After the factor ratio is calculated and multiplied with the input image value (Ri, Gi, Bi), it is obtained that the output image value (Ro, Go, Bo) is

Ro=FR×Ri=1.167×50=58.35

Go=FR×Gi=1.167×100=116.7

Bo=FR×Bi=1.167×150=175.05

Please refer to FIG. 6C, which is the image in FIG. 6A after image processing. It can be derived that

$$\begin{matrix}Ri \text{:} Gi \text{:} Bi = 50 \text{:} 100 \text{:} 150 \\ = 1 \text{:} 2 \text{:} 3 \\ = Ro \text{:} Go \text{:} Bo \\ = 58.35 \text{:} 116.7 \text{:} 175.05\end{matrix}$$

Therefore, it is believed that the hue of the image is unchanged after image processing.

Moreover, the average picture level is 150 as a result of histogram analysis on max(Ri, Gi, Bi). The backlight modulation ratio (BackDim) is calculated as follows:

BackDim=(150/510)+0.5=0.79

Please further refer to FIG. 6D, which is the image in FIG. 6C after backlight modulation. It is found that the output image is similar to the original image as shown in FIG. 6A after 21% reduction of backlight. The present invention effectively achieve reduced power consumption.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A method for backlight modulation and image processing, comprising steps of:
acquiring an average picture level (APL) by analyzing an image data and acquiring a backlight modulation ratio according to the average picture level;
acquiring a first brightness factor by analyzing the image data and resetting the first brightness factor to a second brightness factor according to a brightness factor reset model;
acquiring a factor ratio according to the first brightness factor and the second brightness factor; and
acquiring an output image value according to the factor ratio and an input image value of the image data;
whereby, backlight modulation is performed according to the backlight modulation ratio and image processing is performed according to the output image value.

2. The method as recited in claim 1, wherein the step for acquiring an average picture level comprises steps of:
pre-determining a pixel percentage;
analyzing the image data to obtain a histogram and a total pixel amount;
acquiring an accumulative pixel amount by accumulating a pixel amount corresponding to each grey scale from high to low;
determining whether the accumulative pixel amount is equal to the product of the total pixel amount and the pixel percentage or larger than the minimum integer of the product of the total pixel amount and the pixel percentage; and
picking up a grey scale as the average picture level when the accumulative pixel amount is equal to the product of the total pixel amount and the pixel percentage or larger than the minimum integer of the product of the total pixel amount and the pixel percentage.

3. The method as recited in claim 1, wherein the step for acquiring an average picture level comprises steps of:
pre-determining a pixel percentage;
determining a difference percentage by subtract the pixel percentage from one hundred percent.
analyzing the image data to obtain a histogram and a total pixel amount;
acquiring an accumulative pixel amount by accumulating a pixel amount corresponding to each grey scale from low to high;
determining whether the accumulative pixel amount is equal to the product of the total pixel amount and the difference percentage or larger than the minimum integer of the product of the total pixel amount and the difference percentage; and
picking up a grey scale as the average picture level when the accumulative pixel amount is equal to the product of the total pixel amount and the difference percentage or larger than the minimum integer of the product of the total pixel amount and the difference percentage.

4. The method as recited in claim 1, wherein the step for acquiring a backlight modulation ratio comprises steps of:
setting a variable;
acquiring a maximum average picture level by reading a bit number of the image data;
acquiring a reference value, the reference value being an integer and larger than the maximum average picture level divided by a difference between 1 and the variable or larger than the minimum integer of the maximum average picture level divided by a difference between 1 and the variable; and
acquiring the backlight modulation ratio equal to the variable plus the average picture level divided by the reference value.

5. The method as recited in claim 1, wherein the first brightness factor is a brightness factor in the YUV model obtained by transforming the image data from the RGB model into the YUV model.

6. The method as recited in claim 1, wherein the brightness factor reset model is a reset curve with a turning point.

7. The method as recited in claim 6, wherein the second brightness factor is larger than the first brightness factor when the first brightness factor is larger than the turning point according to the brightness factor reset model.

8. The method as recited in claim 6, wherein the second brightness factor is smaller than or equal to the first brightness factor when the first brightness factor is smaller than the turning point according to the brightness factor reset model.

9. The method as recited in claim 6, wherein the second brightness factor is equal to the first brightness factor when the first brightness factor is equal to the turning point according to the brightness factor reset model.

10. The method as recited in claim 1, wherein the factor ratio is obtained by dividing the second brightness factor by the first brightness factor.

11. The method as recited in claim 1, wherein the output image value is obtained by multiplying the input image value with the factor ratio.
